(19) United States
(12) Patent Application Publication
(10) Pub. No.: US 2022/0202637 A1
(43) Pub. Date: Jun. 30, 2022

(54) Assembling Negative Pressure Isolation Chamber

(71) Applicants: Xing Li, Coquitlam (CA); Haoyu Li, New York, NY (US); Haoxuan LI, New York, NY (US)

(72) Inventors: Xing Li, Coquitlam (CA); Haoyu Li, New York, NY (US); Haoxuan LI, New York, NY (US)

(21) Appl. No.: 17/578,719

(22) Filed: Jan. 19, 2022

(30) Foreign Application Priority Data
Dec. 28, 2020 (CN) 112237521A

(51) Int. Cl. A61G 10/00; A61G 10/02; E04B 1/88; E04H 3/08; F24F 7/08

(52) U.S. Cl. CPC A61G 10/005; A61G 10/02; F24F 13/02; E04H 3/08; F24F 7/08; E04B 1/88

(57) ABSTRACT

The invention discloses an assembly type negative pressure isolation chamber, in which the necessary configuration of the negative pressure isolation ward is contained in a hexahedral chamber. The chamber forms an independent building assembly unit, which can be integrated into or removed from the building system. The chamber can also be disassembled and transported, and the switching of use functions can be realized through the flexible combination and simple modification of components. The indoor wall of the chamber is light Clean and washable materials are integrated with furniture. The air conditioning system adopts internal circulation return air and independent temperature regulating device. The sewage pre disinfection link is added to the sewage system. The negative pressure isolation chamber can help the medical isolation building system expand rapidly in case of respiratory infectious disease outbreak and can carry out space mobility with the transfer of the epidemic situation.

### RELATED APPLICATIONS

The present invention is a continuation of, was first described in, and claims the benefit of Foreign Application No. CN112237521A/201010806611, filed Oct. 11, 2020, the entire disclosures of which are incorporated herein by reference.

### FIELD OF THE INVENTION

The present invention relates generally to a medical isolation facility to restrict air born disease.

### BACKGROUND OF THE INVENTION

The existing such facilities are mainly negative pressure isolation wards which are built in the hospital building. However, the existing negative pressure isolation ward has obvious defects in the following aspects:

It has no flexibility to deal with the fast coming and going of air born disease like SARS or COVID 19. The existing negative pressure isolation ward is normally built in the traditional building. When COVID 19 comes suddenly, the amount of the wards won't be enough. Once COVID 19 has gone, the amount of the wards will be too much for a normal hospital to keep.

It has no flexibility to deal with the fast moving of air born disease like SARS or COVID 19. Once the COVID 19 moves to other cities or countries, the existing negative pressure wards will be demolished, and new negative pressure wards need to be built in other places.

It has no flexibility to change the function to other kind of facilities. For instance, it cannot be changed into a hotel room when the COVID 19 has gone. Or, when the COVID 19 comes back again, a hotel room won't be able to be changed into a negative pressure ward.

The cleaning standard of existing negative pressure ward needs to be updated, since the walls are not washable and there are too many unreachable places between the furniture and the walls.

The HVAC system of existing negative pressure wards needs to be improved, since the central air returning system will bring infectious air to other wards or it will consume too much energy if the central returning system is shut down.

The sewage system of existing negative pressure wards needs to be improved, since the infectious sewage will travel through pipes in other wards in the existing system.

### SUMMARY OF THE INVENTION

The In order to overcome the defects of the existing facilities, the invention provides an assembling chamber to contain the content of a typical negative pressure ward. The chamber is independent from the build and can be moved in and out. The framework of the building can carry more or less chambers so that the capacity of the build is changeable. The chamber can be disassembled into standard parts so that it can be transported. It can be also transformed so that it can change the function. The chamber will build the furniture in the walls so that there will be no gape s between furniture and walls. The HVAC system of the chamber has inner air returning system so that the infectious air won't go to other wards. The sewage system of the chamber contains independent water treatment system so that the infectious sewage will infectious sewage will be treated before it arrives in the public pipe system. be treated before it arrives in the public pipe system.

More detailed description is as follows: The chamber is a hexahedral one. one. It comprises a comprises a patient room, a, a doctor buffer room and a buffer room and a patient toilet. The patient room opens a first outer door to the opens a first outer door to the patient (soiled) corridor and the doctor buffer room opens a second outer door to the buffer room opens a second outer door to the staff (clean) corridor. The patient room opens the first inner door the first inner door to the patient toilet and the second inner door to the staff to the patient toilet and the second inner door to the staff buffer door. The second outer door and the he second outer door and the second inner door in the buffer room have second inner door in the buffer room have interlocking function and emergency unlocking function, inter locking function and emergency unlocking function.

The patient room has an observation an observation window, which cannot be opened and a transfer window, which is a box with interlocking and a transfer window, which is a box with interlocking internal and external doors, internal and external doors, to the direction of the staff corridor. The daylighting window is to the direction of the patient corridor. The patient room will contain to the direction of the patient corridor. The patient room will contain one or more one or more wheeled beds and the medical gas devices. The buffer room is provided with closets for clean and for clean and soiled things.

What is also provided in this room is a doctor's hand washing device with a doctor's hand washing device with an automatic induction faucet. The toilet is provided with a patient's hand washing device, a toilet is provided with a patient's hand washing device, a toilet, a shower and a toilet, a shower and a soiled cabinet. The toilet also has a transfer window with interlocking with interlocking doors to the direction of the patient corridor. The HVAC will create the negative pressure The HVAC will create the negative pressure environment exactly as a normal negative pressure ward's HVAC will do. environment exactly as a normal negative pressure ward's HVAC will do.

When the patient room long enough to enough to place three or more three or more wheeled beds, beds, a storage room may be added between the buffer room and the toilet, the storage room is a room for patients between the buffer room and the toilet, the storage room is a room for patients to store personal belongings.

The chamber is made of light and solid materials. All surrounding walls have double shells. All surrounding walls have double shells. There are also spaces in There are also spaces in ceiling and flooring structure. The ceiling and flooring structure. The pipelines and equipment are laid pipelines and equipment are laid in the spaces. And sound insulation and thermal insulation materials are filled in and thermal insulation materials are filled in. All systems in the chamber can be connected to the public system in the building through outlets. in the chamber can be connected to the public system in the building through outlets.

The patient corridor will be raised to the level of the patient room with the framework will be raised to the level of the patient room with the framework structure. structure. The main pipeline of the building system is laid under the building.

The chamber will be manufactured in the factory and then transported to the construction and then transported to the construction site. Once the chamber arrives at the site, it will be lifted to the level of the floor that it will be chamber arrives at the site, it will be lifted to the level of the floor that it will be installed and moved into the building. Only then, installed and moved into the building. Only then, the external wall and the raised corridor will be installed.

The chamber can be transformed by switching the position of the n of the first outdoor and the first outdoor and the second outdoor parts, each of which, each of which is identical for both the shape and the assembling is identical for both the shape and the assembling structure. By doing this, the chamber can be transformed into hotel room or so on since it the chamber can be transformed into hotel room or so on since it will has only one door facing one corridor as will has only one door facing one corridor as a normal hotel room or apartment.

For the chamber with storage room, storage room, the wall between the patient room and the storage is the wall between the patient room and the storage is removeable. By removing the wall, the storage can be transformed into a bar for hotel room or apartment.

The framework of the hospital building should leave certain amount of spare space for a sky garden or other decoration. Once the pandemic comes, the spare space will be filled with more chambers.

The hospital should be associated with a hotel or apartment building. Once the pandemic comes the hospital should be associated with a hotel or apartment building. Once the pandemic comes the hotel or apartment building can be transformed into negative pressure isolation building.

The chamber uses washable materials for the shell and integrated all furniture with the walls, so that the cleaning standard of the chamber will be updated and easily maintained.

The HVAC system in chamber contains an inner air returning pipe system with fan, so that the infectious air will be either exhausted or sucked into the inner returning system and will never infectious air will be either exhausted or sucked into the inner returning system and will never go to other chambers. go to other chambers.

The chamber will have a micro water treatment machine under the raised floor so that the sewage will be treated immediately after it is flushed—before it arrives in the public pipe system.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is the axonometric diagram of the invention;

FIG. 2 is a plan of the invention;

FIG. 3 is a ceiling plan of the invention;

FIG. 4 is an elevation of the invention along lines A-A in FIG. 2;

FIG. 5 is a cross sectional diagram of the invention [case 1] along lines B-B in FIG. 2;

FIG. 6 is the diagram of case 1 of the invention;

FIG. 7 is a schematic diagram of component transposition in case 1 of the invention;

FIG. 8 is the plan of the chamber transforming in case 1;

FIG. 9 is a plan of the hotel room transformed in case 1;

FIG. 10 is the diagram of HVAC system of case 1 of the invention;

FIG. 11 is an enlarged diagram of point D in FIG. 1;

FIG. 12 is a diagram of the sewage machine;

FIG. 13 is a plan of case 2;

FIG. 14 is a ceiling plan of case 2;

FIG. 15 is a cross section of case 2 along the C-C line in FIG. 13;

FIG. 16 is the plan of the chamber transforming in case 1;

FIG. 17 is a plan of the hotel room transformed in case 1;

FIG. 18 is a plan of student dormitory transformed in the second case.

In the FIG.s: 1. Chamber, 2. Patient corridor, 3. Staff corridor, 4. Patient room, 5. Staff Buffer room, 6. Patient Toilet, 7. First outer door, 8. Second outer door, 9. First inner door, 10. Second inner door, 11. Third inner door, 12. Observation window, 13. Cleaning transfer window, 14. door, 15. First daylighting window, 16. Second daylighting window, 17. Third daylighting window, 18. Wheeled bed, 19. Medical gas equipment belt, 20. bed, Soiled clothes Cabinet, 21. Clean clothes Cabinet, 22. Doctor's hand washing device, 23. Patient's hand, 24. Toilet, 25. Shower, 26. Main air supply outlet, 27. Secondary air supplier, 28. First air supply outlet, 29. Second air supply outlet, 30. First air outlet, 31. Second outlet, 32. Third air outlet, 33. Fourth air outlet, 34. Exhaust pipe, 35. Toilet exhaust pipe, 36. Supply air duct, 37. External connection of supply air duct, 38. External connection of exhaust air duct, 39. External connection of toilet exhaust air duct, 40. Air duct joint, 41. Rib exhaust air duct, 42. Cabin roof, 43. Ceiling, 44. Overhead keel, 45. 46. Structural floor, 47. First part, 48. Second part, 49. Third part, 50. Fourth part, 51. Fifth part, 52. Sixth part, 53. Concave groove, 54. Convex edge, 55. L-shape Concave, 56. L-shaped Convex, 57. Through socket, 58. Through barrel, 59. Bolt hole, 60. Strip manhole, 61. Square manhole, 62. Circular concave, 63. First hole, 64. Second hole, 65. First member, 66. Second member, 67. Bedside groove, 68. Storage groove, 69. Wall mounted folding table, 70. Modular ceiling, 71. First return air pipe, 72. Second return air pipe, 73. Fan, 74. Gas heating device, 75. Sewage pre disinfection device, 76. Inlet pipe, 77. Serpentine pipe, 78. Outlet pipe, 79. Intelligent control system for sewage treatment, 80. Inlet valve, 81. Outlet valve, 82. Air flow mixing device, 83. Gas pipeline, 84. Blower, 85. Disinfectant dosing device, 86. General inpatient ward, 87 Hotel room, 88. Student dormitory, 89. Ordinary outer door, 90. Normally closed door, 91. Guide rail, 92. Lamps, 93. Bed set, 94. Storage room, 95. Doctor preparation room, 96. Cloakroom, 97. Partition pass, 98. Movable partition, 99. Bar, 100. Desk, 101. Ordinary hand washing device, 102. Ordinary storage cabinet, 103. Patient storage cabinet, 104. Soiled temporary storage cabinet, 105. Cabin shell, 106. Bulkhead, 107. Bilge, 108. Bolt connection point, 109. Wall hanging cantilever bracket, 110. Hook, 111. Multi-function universal head.

### DESCRIPTION OF THE PREFERRED EMBODIMENTS

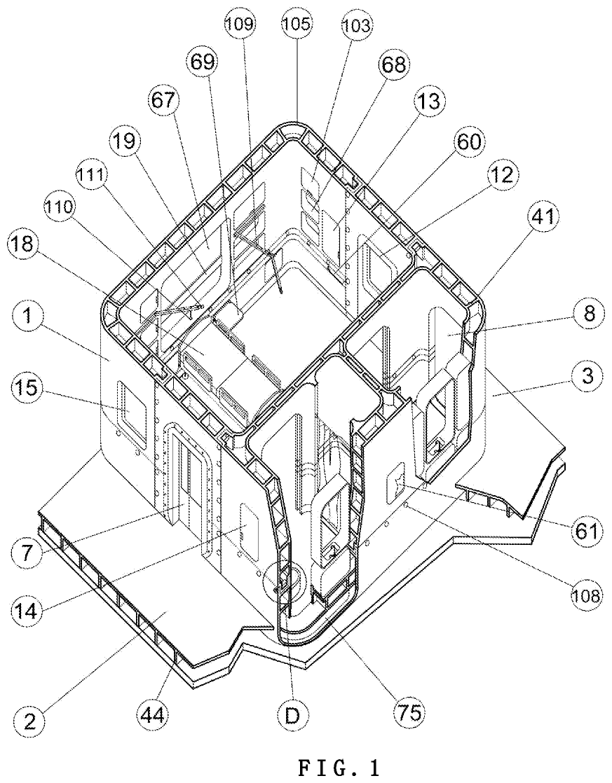

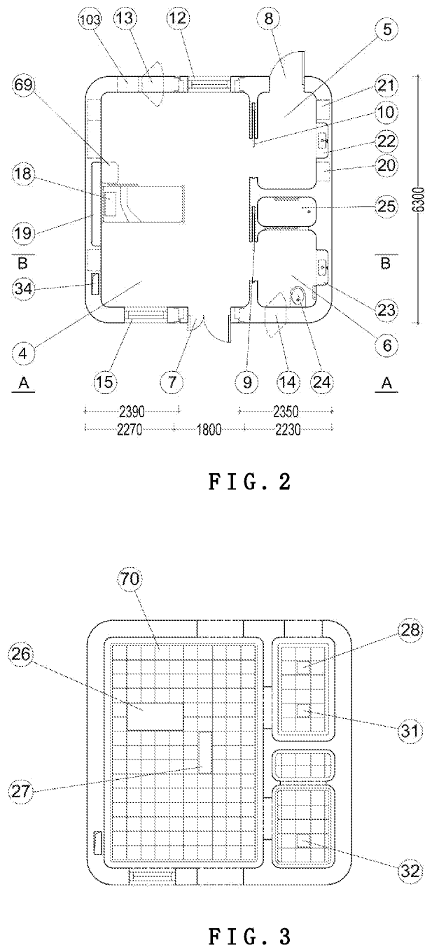

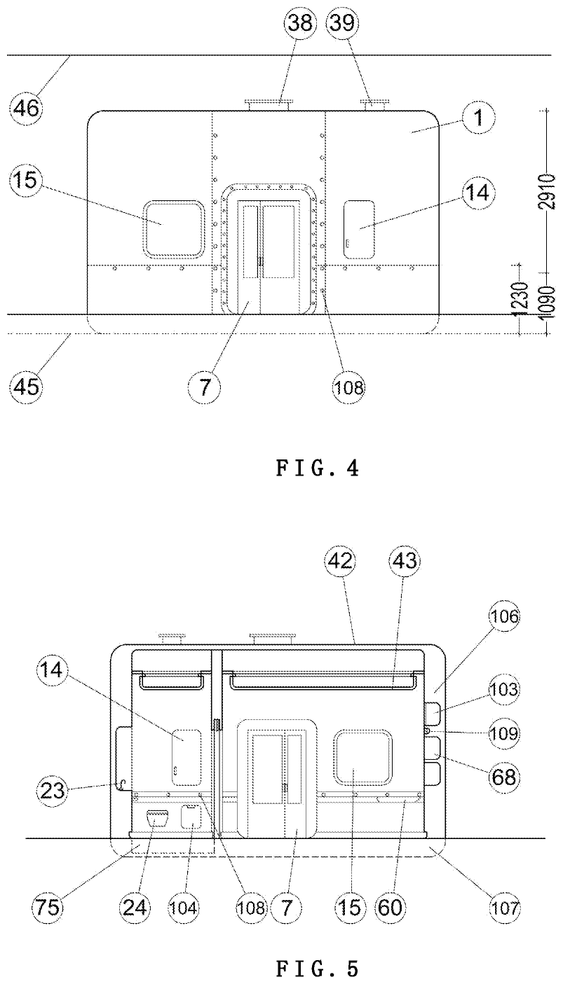

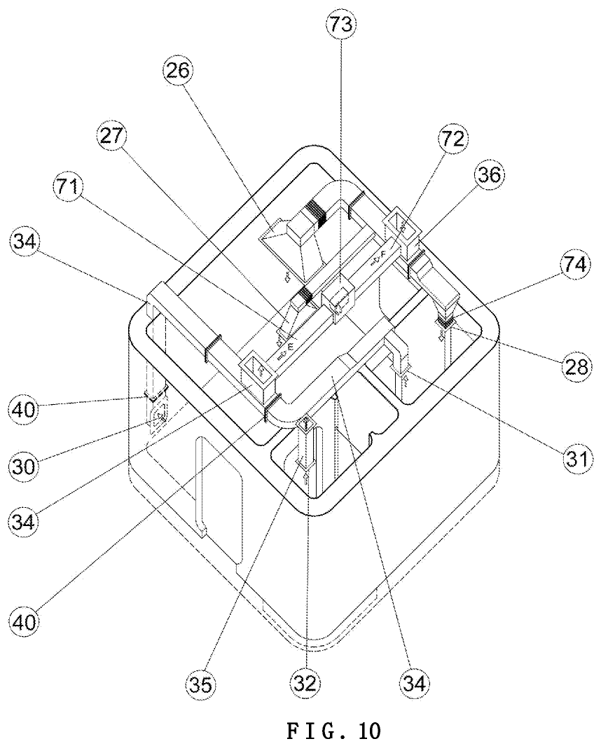

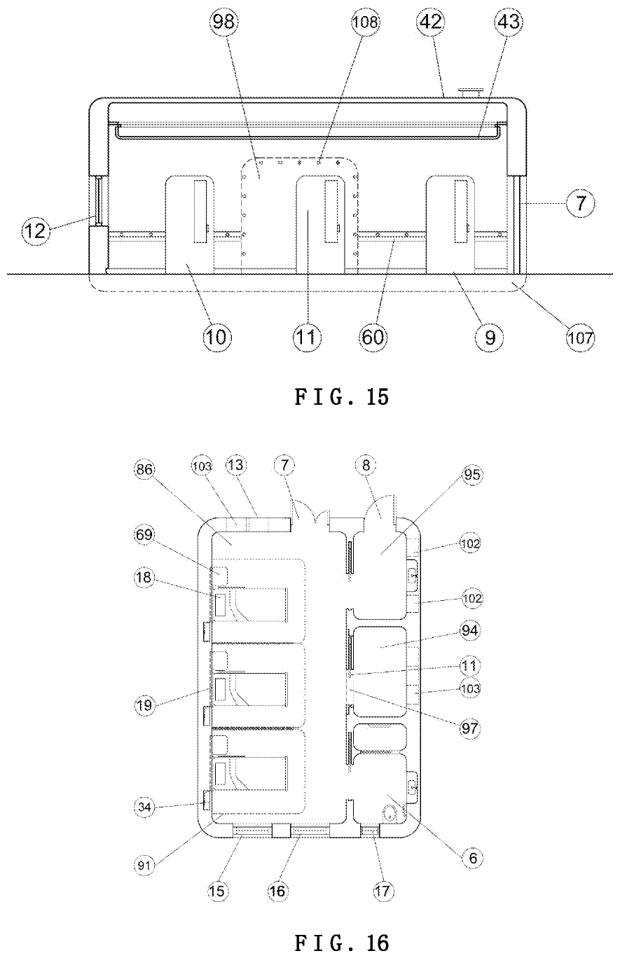

The best mode for carrying out the invention is presented in terms of its preferred embodiment, herein depicted within FIGS. 1 through 18. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

As shown in FIGS. 1 to 12: the assembled negative pressure isolation cabin is a hexahedral cabin body 1, and an indoor space is contained in the cabin body and comprises a ward 4, a buffer room 5 and a toilet 6; wherein the ward 4 is positioned at one side, and the buffer room 5 and the toilet 6 are positioned at the other side in parallel; a ward 4 is provided with a first outer door 7 to a pollution corridor 2, a buffer room 5 is provided with a second outer door 8 to a semi-pollution corridor 3, the pollution corridor 2 is a corridor through which patients pass, the semi-pollution corridor 3 is a corridor through which medical workers pass, and the pollution corridor 2 and the semi-pollution corridor 3 are respectively positioned at two ends of a cabin body 1 to form a room layout mode of a double corridor; a first inner door 9 is arranged between the ward 4 and the toilet 6, and a second inner door 10 is arranged between the ward 4 and the buffer room 5; the second outer door 8 and the second inner door 10 in the buffer room 5 have an interlocking function and an emergency unlocking function; an observation window 12 is arranged on the wall surface of the ward 4 adjacent to the semi-polluted corridor 3, and the observation window 12 is a closed window which cannot be opened; the same wall surface is also provided with a cleaning object transfer window 13, and the cleaning object transfer window 13 is a closed box body with two ends respectively provided with an inner opening fan and an outer opening fan with interlocking function; a first lighting window 15 is arranged on the wall surface of the ward 4 adjacent to the polluted corridor 2; the sickroom 4 is internally provided with a movable sickbed 18, a patient storage cabinet 103 and a storage groove 68, and the wall surface close to the bedside is provided with a medical gas equipment belt 19 and a bedside groove 67; a sewage cabinet 20, a clothes cleaning cabinet 21 and a doctor hand washing device 22 are arranged in the buffer room 5, and the doctor hand washing device 22 is provided with an automatic induction tap; a patient hand washing device 23, a toilet bowl 24, a shower room 25 and a temporary sewage storage cabinet 104 are arranged in the toilet 6, a sewage transfer window 14 is arranged on the wall surface of the toilet 6 adjacent to the polluted corridor 2, and the sewage transfer window 14 is a closed box body with inner and outer opening fans with interlocking functions at two ends; the air in the indoor space is controlled by the air conditioning system to form negative pressure relative to the surrounding environment, ordered negative pressure gradient and directional air flow are formed among all the areas, and meanwhile, the air pressure difference value is continuously monitored and automatically adjusted by the air conditioning intelligent control system connected with the pressure difference sensor; a main air supply outlet 26, a secondary air supply outlet 27 and a first exhaust outlet 30 are arranged in the ward 4, wherein the main air supply outlet 26 is arranged on a ceiling 43 of a conventional standing position of medical staff, the secondary air supply outlet 27 is arranged on the ceiling 43 in the direction of the tail of the bed, the first exhaust outlet 30 is arranged below the wall in the direction of the head of the bed and is respectively positioned at two sides of the movable sickbed 18 together with the main air supply outlet 26; a first air supply outlet 28 and a second air outlet 31 are arranged in the buffer room 5, wherein the first air supply outlet 28 is arranged on the ceiling 43 in the direction of the second outer door 8, and the second air outlet 31 is arranged on the ceiling 43 in the direction of the second inner door 10; the toilet 6 is provided with a third air outlet 32 without an air supply outlet, the third air outlet 32 is arranged on the ceiling 43 of the toilet 24, and the toilet air exhaust pipe 35 is independently arranged and is directly led out of the room.

The cabin body 1 is made of glass fiber reinforced plastics, is mutually independent from a building system and forms a building assembly unit and can be integrally installed in or removed from the building system. An interlayer space is formed between the cabin wall 106 and the cabin bottom 107 of the cabin body 1 and between the inner cabin shell 105 and the outer cabin shell 105, and transverse ribs 41 and longitudinal ribs 41 are arranged in the interlayer space to enhance the structural strength of the cabin body; a ceiling space is arranged between the cabin top 42 and the ceiling 43, pipelines and installation equipment are laid in the interlayer space and the ceiling space, and sound insulation and heat preservation cotton is filled in the interlayer of the cabin wall 106; the cabin body 1 is provided with external interfaces, wherein the external interfaces comprise an air supply pipe external interface 37, an air exhaust pipe external interface 38, a toilet air exhaust pipe external interface 39, a water supply and drainage pipe and sewage exhaust pipe external interface, a strong and weak current pipeline external interface and a medical gas pipeline external interface; the air supply pipe external interface 37, the air exhaust pipe external interface 38 and the toilet independent air exhaust pipe external interface 39 are respectively provided with an air pipe flange, the water supply and drainage pipe and the sewage discharge pipe external interface are respectively provided with a water pipe flange, the strong and weak current external interfaces are respectively provided with a strong current disc and a weak current disc, and the medical gas pipeline external interface is provided with an air transmission pipe flange; the cabin body 1 can be in butt joint with or separated from a main pipeline in a building system through an external interface, so that heating ventilation, water supply and drainage and electrical equipment in the cabin body can operate by depending on a centralized system and can also be separated from the centralized system so as to be convenient for the cabin body to be moved out of the building system.

The polluted corridor 2 and the semi-polluted corridor 3 are overhead corridors, the overhead corridors are overhead above a structural ground 45 through overhead keels 44, the overhead height of the overhead corridors is the same as the thickness of a cabin bottom 107, the ground in the cabin is flush with the ground of the corridors, and a main pipeline of a building system is laid below the overhead corridor on one side of the far end of the building outer wall; space is reserved between the tank roof 42 and the structural floor 46 for installing lifting rails and laying pipelines.

The cabin body 1 is produced in a factory by adopting an industrialized production technology, and then is transported to a building system on a construction site from the factory for assembly and installation; the building system is built on site in a construction site, and the completion degree only needs to be provided with a structural frame, a heating ventilation system, a water supply and drainage system, an electric centralized system and a main pipeline. When the cabin body 1 is installed in a building system, the cabin body is lifted to a required floor from the outside of the structural frame by the lifting equipment, and then the cabin body is pushed to a proper plane position through the lifting track and the transmission device in the structural frame, and then the installation of the outer wall and the overhead corridor on one side of the near end of the outer wall is completed. When the cabin body 1 is moved out of a building system, firstly, the overhead corridor and the outer wall close to one side of the near end of the outer wall are removed, then, the cabin body is horizontally pushed out of the structural frame through the hoisting track and the transmission device, and then, the cabin body is lowered to the ground through hoisting equipment.

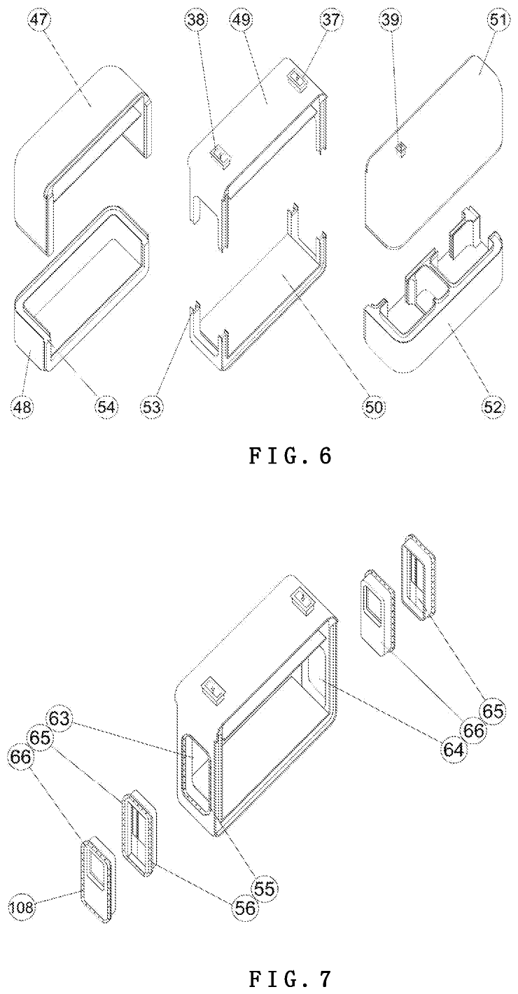

As shown in FIG. 6, the cabin 1 is assembled from components and can be disassembled again for transportation, the components including a first component 47, a second component 48, a third component 49, a fourth component 50, a fifth component 51 and a sixth component 52; wherein the first, second, third and fourth units 47, 48, 49 and 50 divide the patient room 4 into two parts, respectively comprising the upper and lower halves thereof; the fifth part 51 and the sixth part 52 respectively comprise the upper half part and the lower half part of the buffer room 5 and the toilet room 6, and also comprise the upper and lower parts of door openings of the second outer door 8, the first inner door 9 and the second inner door 10, and when the fifth part 51 and the sixth part 52 are assembled and form the complete door opening, the door leaf can be installed; the overall dimensions of the component are: first member 47: length 6.3 meters, width 2.39 meters, height 2.91 meters, second member 48: length 6.3 m, width 2.39 m, height 1.23 m, third part 49: length 6.3 m, width 1.8 m, height 2.91 m, fourth component 50: length 6.3 m, width 1.8 m, height 1.23 m, fifth part 51: length 6.3 meters, width 2.35 meters, height 2.91 meters, sixth member 52: the length is 6.3 meters, the width is 2.35 meters, the height is 1.23 meters, and the sizes all meet the size limit requirements of road transportation packages specified by the current national standard; after disassembly, the cabin can be transported by road transport from the factory to the assembly site or from one assembly site to another.

The parts adopt detachable assembly mode interconnect when the equipment, detachable assembly mode be: the edges of adjacent parts form one of step-shaped lap joints and the other lap joint, one of the lap joints forms a concave groove 53, the other lap joint forms a convex strip 54, the concave groove 53 and the convex strip 54 are overlapped and lapped with each other, and the adjacent parts are connected or separated by assembling or disassembling bolted joints or threaded barrel bolted joints 108 continuously arranged along the overlapped and lapped area; when the splicing of adjacent parts is positioned on the cabin roof 42 without an interlayer, bolt connection points are adopted; the penetrating barrel connection point 108 is used when the splice of adjacent components is located in the jacketed bulkhead 106 or bilge 107.

The bolt connecting points comprise bolt holes, bolts and nuts, the bolt holes are formed in the corresponding positions of the connected pieces which are overlapped and lapped with each other, and the diameters of the bolt holes are matched with the diameters of the bolts and the nuts; during assembly, the bolt penetrates through the bolt hole and is screwed into the nut so as to connect and fix the connected piece; when the connecting piece is disassembled, the bolt is unscrewed so that the connected piece is separated. The bolt connection point adopts a common connection mode, so that the attached drawing marks are not adopted.

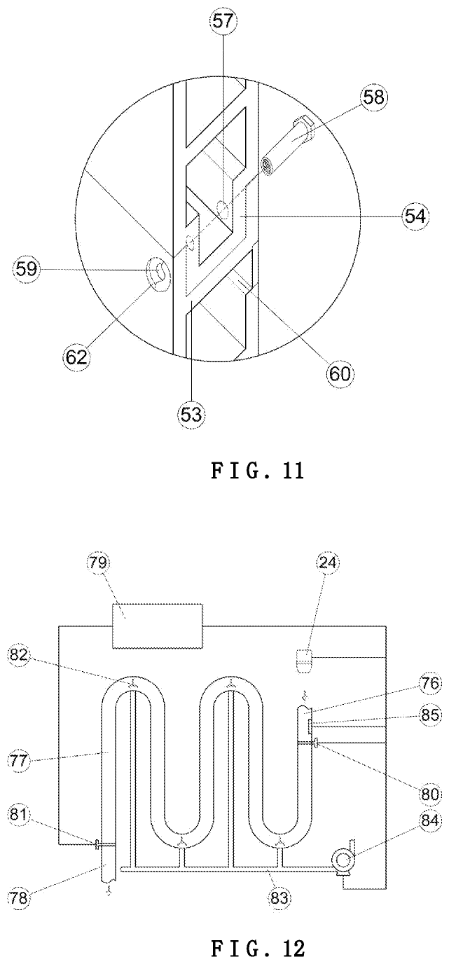

As shown in FIG. 11, the insertion cylinder bolt connection point 108 includes an insertion hole 57, a bolt hole 59, an insertion cylinder 58 and a bolt, wherein the diameter of the insertion hole 57 is larger than that of the bolt hole 59; the through inserting holes 57 at one side of the interlayer and the bolt holes 59 at the other side of the interlayer are overlapped and overlapped with each other; the inserting cylinder 58 is of a cylindrical structure, the length of the inserting cylinder is slightly larger than the clear width of the interlayer, one end of the inserting cylinder is an opening, the other end of the inserting cylinder is a closed end and is provided with a hexagonal nut, threads are arranged in the inserting cylinder, the outer diameter of the cylinder body of the inserting cylinder 58 is matched with the inserting hole 57, and the inner diameter of the inserting cylinder is matched with a bolt; the outer diameter of the bolt is matched with the bolt hole 59 and a hexagonal nut is arranged; during assembly, the inserting cylinder 58 is inserted into the inserting hole 57 from one side of the inserting hole 57 and penetrates through the bulkhead interlayer to abut against the connected piece on the other side of the bulkhead interlayer, and then a bolt is inserted into the bolt hole 59 from one side of the bolt hole 59 and extends into the opening of the inserting cylinder 58 to be screwed tightly, so that the connected piece is connected and fixed; when the connecting piece is disassembled, the bolt or the inserting cylinder 58 can be unscrewed from one side which is convenient to operate so as to separate the connected piece. A circular notch 62 is arranged on the outer side surface of the interlayer of the connected piece at the through hole 57 and the bolt hole 59, the depth of the circular notch 62 is slightly larger than the thickness of the nut, so that the nut does not protrude out of the surface of the connected piece after being screwed, and the inner diameter of the circular notch 62 is larger than the outline size of the nut, so as to reserve an operation space for screwing or unscrewing the nut by using a tool; the circular recess 62 is closed by a circular cover plate, the surface of which is flush with the surface of the connected piece.

Pipeline joints are arranged in the interlayer of the cabin wall 106 and the cabin bottom 107 and in the suspended ceiling space when crossing the splicing part, the pipeline joints comprise air pipe joints 40, water pipe joints, strong and weak electric pipeline joints and medical gas pipeline joints, the air pipe joints 40 adopt air pipe flanges, the water pipe joints adopt water pipe flanges, the strong and weak electric pipeline joints adopt electric wire or data wire connectors, and the medical gas pipeline joints adopt gas transmission pipe flanges; a strip-shaped access hole 60 is arranged at the splicing part of the horizontal components of the cabin wall 106 in the cabin, so that the pipeline joints can be connected or separated, and the strip-shaped access hole 60 is usually sealed by a strip-shaped cover plate; in the area where the operation surface is larger than the strip-shaped access opening, a square access opening 61 capable of covering the operation surface is arranged outside the cabin, and the square access opening 61 is usually sealed by an access opening cover plate; all pipelines do not directly cross the splicing parts of the components at the vertical direction or the bilge, and if the pipelines need to cross, the pipelines firstly extend upwards to the ceiling space and then cross from the ceiling space; the connection or disconnection of the line connections within the ceiling space can be done before or after the modular ceiling 70 is laid on the ceiling; PVC coiled material floor is laid on the ground of the cabin body, and the joint is sealed by adopting a hot welding technology and rolled up at the skirting position; the operations of connecting and disconnecting the pipe joints of the interlayer of the bilge 107 can be performed before or after the floor is laid.

As shown in FIG. 7, the third part 49 and the fourth part 50 respectively include an upper half and a lower half of a first hole 63 and a second hole 64, the first hole 63 is located in the direction of the contaminated corridor 2, the second hole 64 is located in the direction of the semi-contaminated corridor 3, and after the third part 49 and the fourth part 50 are assembled and form the complete first hole 63 and second hole 64, the first hole 63 and the second hole 64 are respectively sealed by a first member 65 and a second member 66; the first member 65 is provided with a first outer door 7, the bottom edge of a door opening is flush with the ground in the cabin after plugging is finished, and the second member 66 is provided with an observation window 12; the component overlaps with the notch through the ladder face of mutual coincide on the adjacent edge, and wherein the notch edge forms L shape notch 55, and the component edge forms L shape arch 56, L shape notch 55 overlaps the overlap joint with the protruding 56 mutual coincide of L shape, component and notch set up in succession along the overlap joint region and alternate a section of thick bamboo bolted connection point 108 to make component and notch can fixed connection or dismantle the separation. The edge size and shape of the first hole 63 and the second hole 64 are completely consistent with the arrangement of the penetrating cylinder bolt connection points 108, and the edge size and shape of the first member 65 and the second member 66 are completely consistent with the arrangement of the penetrating cylinder bolt connection points 108; therefore, the first member 65 and the second member 66 can be flexibly combined and mutually exchanged, so that the first outer door 7 and the observation 12 window can also be flexibly exchanged; when the first outer door 7 is shifted to the direction of the second opening 64, the observation window 12 is shifted to the direction of the first opening 63 and is shifted to the second lighting window 16, the room layout of the cabin 1 is shifted to the single corridor mode, so that the building system supporting the single corridor mode can be shifted.

The sewage transfer window 14 can be integrally disassembled and modified into a third lighting window 17 according to the original window hole, the medical gas equipment belt 19 can be integrally closed by a cover plate, and a lamp 92 can be additionally arranged on the cover plate; the enclosure converted into the single corridor mode can be changed from the medical isolation facility to the ordinary medical or civil facility by the above-mentioned modification and simple change.

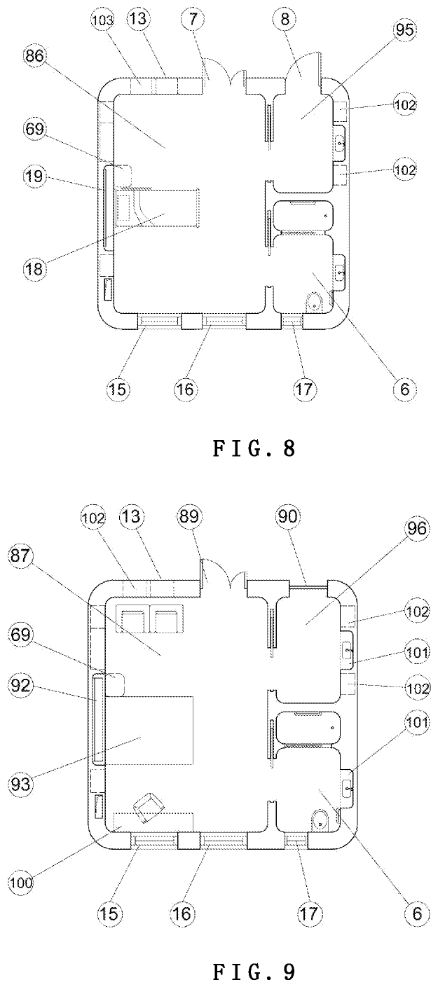

As shown in FIG. 8, after the cabin is converted into the single corridor mode, the use function can be switched from the medical isolation facility to the general hospital hospitalization facility by simple modification and change, which includes: locking an inner opening fan and an outer opening fan of a cleaning object transfer window 13, integrally removing an original dirt transfer window 14 and modifying the original dirt transfer window into a third lighting window 17, modifying an original buffer room 5 into a doctor preparation room 95 to be used as a place for preparing activities such as washing hands before a doctor enters and leaves a ward, and modifying an original dirt wardrobe 20 and an original cleaning wardrobe 21 into a common storage cabinet 102; the above adaptations or changes can be resumed so that the functional use of the enclosure is switched back to the medical isolation facility again.

As shown in FIG. 9, after the cabin is converted into the single corridor mode, the use function can be switched from the medical isolation facility to the hotel facility by simple modification and change, which includes: the original first outer door 7 is changed into a common outer door 89, the original second outer door 8 is changed into a normally closed door 90 through a door lock, the inner and outer opening leaves of the cleaning object transfer window 13 are locked, the original sewage transfer window 14 is integrally detached and modified into a third lighting window 17, the original buffer room 5 is changed into a cloakroom 96, the original sewage cabinet 20, the original clothes cabinet 21 and the original patient storage cabinet 103 are changed into a common storage cabinet 102, the original doctor hand washing device 22 and the original patient hand washing device 23 are changed into a common hand washing device 101, the medical gas equipment belt 19 is sealed by a cover plate and modified into a bedside lamp 92, the movable sickbed 18 is changed into a hotel bed 93, and the original sickroom 4 is changed into a hotel guest room 87: the above adaptations or changes can be resumed so that the functional use of the enclosure is switched back to the medical isolation facility again.

When the cabin functions as a negative pressure isolation facility, a certain proportion of cabin vacant spaces are reserved in the supported building system; in the usual time, these vacant spaces can be used as three-dimensional gardens or decorative spaces, which can reduce the running cost and improve the environmental conditions; when an epidemic situation occurs suddenly, the cabins can be moved into the vacant spaces, so that the scale of the negative pressure isolation building system can be rapidly expanded; the newly moved cabin body can be from a new product of a factory or a cabin body which is assembled in a common medical facility or a civil facility and can be switched in function; or when the epidemic situation is transferred regionally, the epidemic situation is derived from the redundant cabin body in the region where the epidemic situation is improved.

When the function of the cabin body is switched to common medical or civil facilities, the supported building system should reserve a structural embedded part and sufficient load, so that the outer wall of the building system can rapidly build an externally-hung glass gallery. When an epidemic situation occurs suddenly, the cabin body can be moved out of the building system supported by the negative pressure isolation facility from the original building system and can be converted into a double corridor mode on site in a mode of additionally building an externally-hung glass corridor, so that the whole layer or whole span of common medical or civil facilities can be converted into the negative pressure isolation facility.

The inner surface of the bulkhead 106 is an indoor wall surface, is formed by directly performing surface treatment on glass fiber reinforced plastic through a polishing process, has the characteristics of smoothness and unlimited water flushing, and is easier for cleaning an indoor environment.

The dirty wardrobe 20, the clean wardrobe 21, the patient storage cabinet 103, the temporary dirty storage cabinet 104, the clean object transfer window 13 and the dirty transfer window 14 are all in the form of embedded furniture, and the embedded furniture is in the form of furniture which is embedded in an interlayer by utilizing the thickness of the interlayer of the bulkhead and enables the surface of an opening leaf or a door of the furniture to be flush with the surface of the bulkhead.

The doctor hand washing device 22, the patient hand washing device 23, the bedside groove 67 and the storage groove 68 are all in the form of niche furniture which is formed by utilizing the thickness of the cabin wall interlayer to form an inner concave space and forming a tabletop on the bottom surface of the niche furniture.

Wall-mounted furniture is arranged on the indoor wall surface, and the wall-mounted furniture comprises a wall-mounted folding table board 69 and a wall-mounted cantilever bracket 109; the wall-mounted folding table board 69 is arranged on the wall surface near the movable sickbed 18, is arranged on the wall surface through a folding support device, is close to the bulkhead and is vertical to the ground when being folded, can be fixed at the horizontal position when being used, and is provided with a corresponding groove so that the wall-mounted folding table board 69 can be accommodated when being folded; wall hanging cantilever 109 locates near removal sick bed 18 and squatting pan 24 wall, and the pedestal mounting is in the wall, but the pole body is single section or multistage and multi-angle adjustment direction, and the couple 110 is established for hanging the transfusion bottle to the pole body, and multi-functional universal head 111 is established to the end, multi-functional universal head 111 is for can connecting multiple accessory and seeing the latch device of multi-angle adjustment direction, multiple accessory includes: the wall surface is provided with a corresponding groove, so that the wall-mounted cantilever support 109 can be accommodated when being folded.

The embedded furniture, the niche-type furniture and the wall-mounted furniture are integrated with the wall, so that sanitary dead angles are effectively reduced, the surface of an indoor environment is smoother and easier to clean, an indoor effective space is more fully released, and the improvement is also made in the aspects of facilitating the examination and treatment of doctors and adapting to the new habits of leisure and social networking of isolated patients.

As shown in FIG. 11, a first air return duct 71, a blower 73 and a second air return duct 72 are arranged between the exhaust duct 34 and the air supply duct 36, wherein the blower 73 is arranged between the first air return duct 71 and the second air return duct 72, an air inlet of the blower 73 is connected with the first air return duct 71, an air outlet of the blower 73 is connected with the second air return duct 72, an air inlet of the blower 73 sucks a part of the air exhausted from the room in the exhaust duct 34 into the first air return duct 71 in the direction of arrow E in FIG. 11, blows the air into the second air return duct 72 through the air outlet in the direction of arrow F in FIG. 11, mixes with the fresh air in the air supply duct 36 and returns the air to the room through the air supply ports, thereby forming an indoor air circulation loop, which allows a part of the treated air to be recycled under the direct exhaust type centralized air supply and exhaust system, thereby achieving the energy saving effect, moreover, as the circulation is completed indoors, cross infection among different capsule bodies is avoided; the fan 73 is controlled by an intelligent air control system, so that the proportion of the internal circulating return air can be controlled by the intelligent air-conditioning control system. And all the tail ends of the air supply pipes 36 are provided with gas heating devices 74, the gas heating devices 74 are electric heating elements, the electric heating elements adopt a group of electric heating pipes, and the gas heating devices are controlled by an air-conditioning intelligent control system connected with a temperature sensor, so that the room temperature of each cabin body can be independently adjusted through the air-conditioning intelligent control system.

The air conditioning system improves energy-saving indexes and comfortableness on the premise of safety and solves the final problem of use function switching. The air conditioning system can set different safe or energy-saving operation modes by controlling the proportion of the internally circulated return air, thereby being suitable for different use functions. The air conditioning system also keeps the working mechanism of internal circulating air return even in the most energy-saving running mode, so that the risk of cross infection of air passing is avoided; therefore, even when the function of the cabin is switched to the common medical or civil facilities, the safety of the air conditioner is better than that of the existing air conditioning system of the common medical or civil facilities.

As shown in FIG. 12, a sewage pre-disinfection device 75 is arranged in an interlayer of the bilge 107, the sewage pre-disinfection device 75 includes a water inlet pipe 76, a coiled pipe 77, a water outlet pipe 78 and an intelligent sewage treatment control system 79, a disinfectant adding device 85 is arranged in the water inlet pipe 76, a water inlet valve 80 is arranged between the water inlet pipe 76 and the coiled pipe 77, a water outlet valve 81 is arranged between the coiled pipe 77 and the water outlet pipe 78, the position of the water inlet valve 80 is higher than the position of the water outlet valve 81, an airflow stirring device 82 is arranged at an elbow of the coiled pipe 77, the airflow stirring device 82 is connected with a blower 84, three support arms extending from the center to the outside are arranged at the tail ends of the three support arms, the three support arms are positioned at the same level, an included angle between the support arms is 120°, nozzles are arranged at the same sides of the tail ends of the, The airflow stirring devices 82 are controlled by the sewage treatment intelligent control system 79; the intelligent sewage treatment control system 79 is linked with the flushing device of the toilet 24, when the flushing device of the toilet 24 is started, the system automatically closes the water outlet valve 81 and starts the disinfectant adding device 85, when the water in the water tank of the toilet 24 is completely flushed, a user can manually or automatically close the water inlet valve 80 and start the airflow stirring device 82, and after a set time, the water outlet valve 81 and the water inlet valve 80 are opened, and sewage after disinfection treatment is discharged into the main sewage discharge pipeline. The sewage pre-disinfection device 75 can be used for making up the epidemic prevention leak of the main sewage pipeline of the medical isolation facility because the disinfection treatment of the sewage is advanced to the place before the sewage is discharged into the main sewage pipeline.

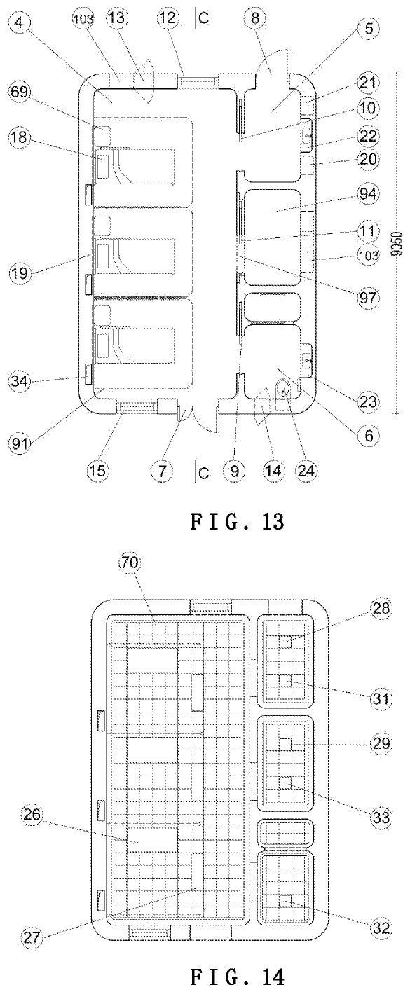

As shown in FIGS. 13 to 18: in this embodiment: three movable sickbeds 18 are arranged in the ward 4, a storage room 94 is arranged between the buffer room 5 and the toilet 6, a third inner door 11 is arranged between the ward 4 and the storage room 94, and a patient storage cabinet 103 is arranged in the storage room 94 for storing personal articles for the patient. The ceiling between the movable sickbeds 18 is provided with a guide rail 91, and a partition curtain is arranged below the guide rail 91 to divide the sickroom into three bed partitions.

As shown in FIG. 14, a main air supply outlet 26, a secondary air supply outlet 27 and a first exhaust outlet 30 are respectively arranged in each bed partition, wherein the main air supply outlet 26 is arranged on the ceiling of the conventional standing position of the medical staff, the secondary air supply outlet 27 is arranged on the ceiling in the direction of the tail of the bed, and the first exhaust outlet 30 is arranged below the wall surface in the direction of the head of the bed and is respectively positioned at two sides of the movable sickbed 18 together with the main air supply outlet 26; a second air supply opening 29 and a fourth air outlet 33 are arranged in the storage room 94, the second air supply opening 29 is arranged on the ceiling in the far end direction of the third inner door 11, and the fourth air outlet 33 is arranged on the ceiling in the near end direction of the third inner door 11.

The cabin 1 has the following overall dimensions after being disassembled into components: first member 47: length 9.05 meters, width 2.39 meters, height 2.91 meters, second member 48: length 9.05 m, width 2.39 m, height 1.23 m, third part 49: length 9.05 m, width 1.8 m, height 2.91 m, fourth component 50: length 9.05 meters, width 1.8 meters, height 1.23 meters, fifth part 51: length 9.05 meters, width 2.35 meters, height 2.91 meters, sixth part 52: the length is 9.05 meters, the width is 2.35 meters, and the height is 1.23 meters, and the sizes all meet the size limit requirements of road transportation packages specified by the current national standard.

The fifth part 51 and the sixth part 52 further respectively comprise an upper half part and a lower half part of the storage room 94 and respectively comprise an upper half part and a lower half part of the partition bealock 97, the partition bealock 97 is an opening on a partition wall between the storage room 94 and the ward 4, and after the fifth part 51 and the sixth part 52 are assembled and form the complete partition bealock 97, the partition bealock 97 is blocked by adopting the movable partition 98; the movable partition 98 is provided with a third inner door 11, and the bottom edge of the door opening is flush with the ground in the cabin after plugging is finished; the activity cuts off 98 and cuts off bealock 97 and adopts detachable equipment mode to be connected, detachable equipment mode be: the adjacent edges of the partition bealock 97 and the movable partition 98 respectively form an L-shaped notch 55 and an L-shaped protrusion 56, the L-shaped notch 55 and the L-shaped protrusion 56 are overlapped and lapped with each other, and the movable partition 98 is connected with or separated from the partition bealock by assembling or disassembling the insertion cylinder bolt connection points 108 continuously arranged along the overlapped and lapped area.

As shown in FIG. 16, after the cabin is converted into the single corridor mode, the use function can be switched from the medical isolation facility to the general hospital hospitalization facility by simple modification and change, which includes: locking an inner opening fan and an outer opening fan of a cleaning object transfer window 13, integrally removing an original dirt transfer window 14 and modifying the original dirt transfer window into a third lighting window 17, modifying an original buffer room 5 into a doctor preparation room 95 to be used as a place for preparing activities such as washing hands before a doctor enters and leaves a ward, and modifying an original dirt wardrobe 20 and an original cleaning wardrobe 21 into a common storage cabinet 102; the above adaptations or changes can be resumed so that the functional use of the enclosure is switched back to the medical isolation facility again.

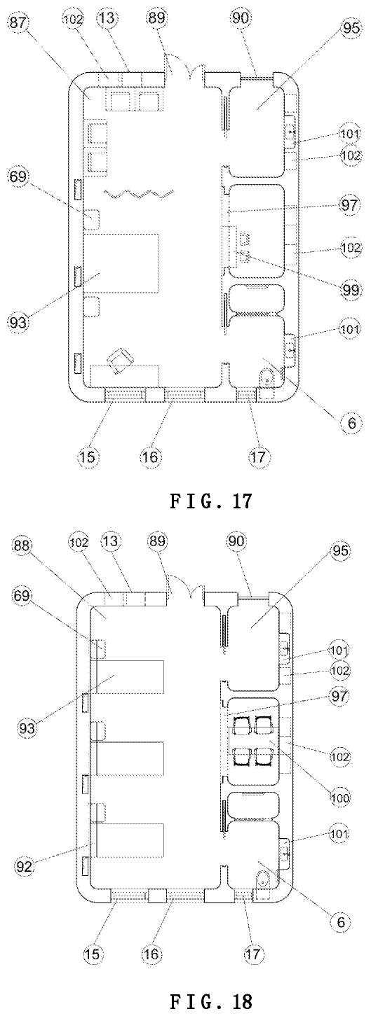

As shown in FIG. 17, after the cabin is converted into the single corridor mode, the use function can be switched from the medical isolation facility to the hotel facility by simple modification and change, which includes: the original first outer door 7 is changed into a common outer door 89, the original second outer door 8 is changed into a normal-closed door 90 through a door lock, the inner and outer opening leaves of the original cleaning object delivery window 13 are locked, the original dirt delivery window 14 is integrally removed and is changed into a third lighting window 17, the original buffer room 5 is changed into a clothes and hat room 96, the original dirty wardrobe 20, the original clean wardrobe 21 and the original patient storage cabinet 103 are changed into a common storage cabinet 102, the original doctor hand washing device 22 and the original patient hand washing device 23 are changed into a common hand washing device 101, a movable partition 98 between the original storage room 94 and the ward 4 is removed and is provided with a bar counter 99, the medical gas equipment belt 19 is closed by a cover plate, the movable sickbed 18 is changed into a hotel bed 93, and the original ward 4 is changed into a hotel guest room 87: the above adaptations or changes can be resumed so that the functional use of the enclosure is switched back to the medical isolation facility again.

As shown in FIG. 18, after the cabin is converted into the single corridor mode, the use function can be switched from the medical isolation facility to the school facility by simple modification and change, which includes: the original first outer door 7 is changed into a common outer door 89, the original second outer door 8 is changed into a normal-closed door 90 through a door lock, the inner opening leaf and the outer opening leaf of a cleaning article transfer window 13 are locked, the original dirt transfer window 14 is integrally detached and changed into a third lighting window 17, the original buffer room 5 is changed into a clothes and hat room 96, the original dirt wardrobe 20, the original clothes wardrobe 21 and the original patient storage cabinet 103 are changed into a common storage cabinet 102, the original doctor hand washing device 22 and the original patient hand washing device 23 are changed into a common hand washing device 101, a movable partition 98 between the original storage room 94 and a ward 4 is detached and a desk 100 is arranged, the medical gas equipment belt 19 is closed by adopting a cover plate and is changed into a bedside lamp 92, the movable sickbed 18 is changed into a dormitory bed tool 93, and the original ward 4 is changed into a student dormitory 88: the above adaptations or changes can be resumed so that the functional use of the enclosure is switched back to the medical isolation facility again.

The present invention is not limited to the above embodiments and based on the technical solutions disclosed in the present invention, those skilled in the art can make some substitutions and modifications to some technical features without creative efforts, and these substitutions and modifications are all within the protection scope of the present invention.

What is claimed is:

1. A fabricated negative pressure isolation cabin, which is a hexahedral cabin (1), and its interior contains an indoor space; the indoor space includes a ward (4), a buffer room (5) and a toilet (6), wherein the ward (4) is located on one side, the buffer room (5) and the toilet (6) are parallel on the other side; the ward (4) opens a first outer door (7) to the pollution corridor (2), and the buffer room (5) opens a second outer door (8) to the semi pollution corridor (3) The polluted corridor (2) is a corridor for patients to pass, the semi polluted corridor (3) is a corridor for medical staff to pass, the polluted corridor (2) and the semi polluted corridor (3) are respectively located at both ends of the cabin (1), forming a double corridor room layout mode; a first inner door (9) is opened between the ward (4) and the toilet (6), a second inner door (10) is opened between the ward (4) and the buffer room (5), and a second inner door (10) is opened in the buffer room (5) The second outer door (8) and the second inner door (10) have interlocking function and emergency unlocking function; the wall adjacent to the ward (4) and the semi polluted corridor (3) is provided with an observation window (12), which is a closed window that cannot be opened; the same wall is also provided with a cleaning transfer window (13), which is a closed box with internal and external opening fans with interlocking function at both ends; the ward (4) The wall adjacent to the pollution corridor (2) is provided with a first daylighting window (15); the ward (4) is provided with one or more mobile beds (18) and patient storage cabinets (103); the wall near the head of the bed is provided with a medical gas equipment belt (19); the buffer room (5) is provided with a dirty wardrobe (20), a laundry cabinet (21) and a doctor's hand washing device (22), and the doctor's hand washing device (22) is provided with an automatic induction faucet; the toilet (6) is provided with a patient's hand washing device A device (23), a toilet (24), a shower room (25) and a waste temporary storage cabinet (104) are arranged. A waste transfer window (14) is arranged on the wall adjacent to the pollution corridor (2) in the toilet (6). The waste transfer window (14) is a closed box with interlocking internal and external opening fans at both ends. The air in the indoor space is controlled by the air conditioning system to form a negative pressure relative to the surrounding environment, and the air flow is controlled by the air conditioning system An orderly negative pressure gradient and directional air flow are formed between each area, and the air pressure difference is continuously monitored and automatically adjusted by an air conditioning intelligent control system connected with a differential pressure sensor; the ward (4) is provided with a main air supply outlet (26), a secondary air supply outlet (27) and a first row of air outlets (30), wherein the main air supply outlet (26) is arranged on the ceiling (43) of the normal station of the medical staff, and the secondary air supply outlet (27) is arranged on the ceiling (43) On the ceiling (43) at the end of the bed, the first air outlet (30) is arranged under the wall at the head of the bed and on both sides of the mobile bed (18) respectively with the main air outlet (26); the buffer room (5) is provided with a first air outlet (28) and a second air outlet (31), wherein the first air outlet (28) is arranged on the ceiling (43) at the direction of the second outer door (8), and the second air outlet (31) is arranged on the ceiling (43) at the direction of the second inner door (10)) The utility model is characterized in that: the cabin (1) is made of light and solid materials, which is independent of the building system and forms a building assembly unit, and can be installed or removed as a whole Building system.

2. The fabricated negative pressure isolation chamber according to claim 1, which is characterized in that: when the depth of the ward (4) is deep enough to set three or more mobile beds (18), a storage room (94) is set between the buffer room (5) and the toilet (6), a patient storage cabinet (103) is set in the storage room (94), a third inner door (11) is opened between the ward (4) and the storage room (94), and a third inner door (11) is opened in the storage room (94) A second air supply outlet (29) and a fourth air outlet (33) are arranged, the second air supply outlet (29) is located on the ceiling (43) at the far end of the third inner door (11), and the fourth air outlet (33) is located on the ceiling (43) at the near end of the third inner door.

3. The fabricated negative pressure isolation tank according to claim 1 or 2, which is characterized in that the bulkhead (106) and bilge (107) of the tank (1) form a sandwich space between the inner and outer tank shells (105), the sandwich space is provided with transverse and longitudinal ribs (41), the ceiling space is provided between the cabin roof (42) and the ceiling (43), and the sandwich of the bulkhead (106) is filled with light sound insulation and heat insulation The cabin (1) is provided with an external interface, which includes an air supply pipe external interface (37), an exhaust pipe external interface (38), a toilet independent exhaust pipe external interface (39), a water supply and drainage pipe and a sewage pipe external interface, a strong and weak current pipeline external interface and a medical gas pipeline external interface; the air supply pipe external interface (37), an exhaust pipe external interface (38) and a toilet independent exhaust pipe external interface The external interfaces (39) of the air pipe adopt the air pipe flange, the external interfaces of the water supply and drainage pipe and the sewage pipe adopt the water pipe flange, the external interfaces of the strong and weak current adopt the strong current panel and the weak current panel, and the external interfaces of the medical gas pipeline adopt the gas pipe flange.

4. The fabricated negative pressure isolation cabin according to claim 3, which is characterized in that the cabin body (1) is assembled by components and can be decomposed into components again for transportation, and the components include a first component (47), a second component (48), a third component (49), a fourth component (50), a fifth component (51) and a sixth component (52); wherein the first component (47) comprises a first component (47), a second component (48), a third component (49), a fourth component (50), a fifth component (51) and a sixth component (52) The ward (4) is divided into two parts, the upper part and the lower part of the two parts respectively, the second part (48), the third part (49) and the fourth part (50); the fifth part (51) and the sixth part (52) respectively include the upper part and the lower part of the buffer room (5) and the toilet (6), and the second outer door (8), the first inner door (9) and the second inner door (5) When the fifth part (51) and the sixth part (52) of the upper and lower parts of the door opening of the inner door (10) are assembled to form a complete door opening, the door leaf can be installed; the external dimensions of the parts meet the requirements of the current national standard for the size limit of highway transportation packaging, that is, the length is less than 12.16 m, the width is less than 2.5 m, and the height is less than 4 m after loading; the detachable assembly method is as follows: one of the stepped lap ends and the other lap end are formed at the edge of the adjacent parts, one of the lap ends forms a concave groove (53), the other lap end forms a convex strip (54), the concave groove (53) and the convex strip (54) are overlapped with each other, and the adjacent parts are overlapped by the opposite edges When the splicing of adjacent components is located at the cabin top (42) without interlayer, the bolt connection point is adopted; when the splicing of adjacent components is located at the bulkhead (106) or bilge (107) with interlayer, the bolt connection point (108) is adopted.

5. The fabricated negative pressure isolation chamber according to claim 4, which is characterized in that: the bolt connection point (108) of the inserting barrel comprises a penetrating socket (57), a bolt hole (59), an inserting barrel (58) and a bolt; the diameter of the penetrating socket (57) is larger than the diameter of the bolt hole (59), and the connecting pieces overlapped with each other are opened at the penetrating socket (57) on one side of the interlayer, and opened at the other side The inserting barrel (58) has a cylindrical structure, the length of which is slightly larger than the net width of the interlayer, one end is open, the other end is closed, and is provided with a hexagon nut, and a thread is arranged in the barrel, the outer diameter of the barrel of the inserting barrel (58) matches the piercing socket (57), and the inner diameter matches the bolt; the outer diameter of the bolt matches the bolt hole (59), and is provided with a hexagon nut.

6. The fabricated negative pressure isolation chamber according to claim 4 or 5, which is characterized in that: the pipelines in the interlayer of the bulkhead (106) and the bilge (107) and in the ceiling space are provided with pipeline joints when crossing the splicing parts of components, the pipeline joints include air pipe joints (40), water pipe joints, strong and weak current pipeline joints and medical gas pipeline joints, and the air pipe joints are made of air pipe joints The water pipe joint adopts a water pipe flange, the strong and weak current pipeline joint adopts a wire or data line connector, and the medical gas pipeline joint adopts a gas pipeline flange.

7. The fabricated negative pressure isolation chamber according to claim 6, which is characterized in that the third part (49) and the fourth part (50) respectively contain the upper half and the lower half of the first opening (63) and the second opening (64), the first opening (63) is located in the direction of the pollution corridor (2), and the second opening (64) is located in the direction of the semi pollution corridor (3) 9) After the first opening (63) and the second opening (64) are assembled with the fourth part (50), the first opening (63) and the second opening (64) are sealed with the first component (65) and the second component (66) respectively; the first component (65) is provided with a first outer door (7), and the bottom edge of the rear opening is flush with the ground in the cabin after the sealing is completed; and The second component (66) is provided with an observation window (12); the component and the hole are connected by a detachable assembly method, and the detachable assembly method is as follows: an L-shaped concave (55) is formed at the edge of the hole, an L-shaped convex (56) is formed at the edge of the component, the L-shaped concave (55) and the L-shaped convex (56) are overlapped and overlapped with each other, and the component is connected by the L-shaped concave (55) and the L-shaped convex (56) which are continuously arranged along the overlapped overlapping area The inserting barrel bolt connection point (108) is connected or separated from the hole through assembly or disassembly operation; the shape and size of the first hole (63) and the second hole (64) and the arrangement of the inserting barrel bolt connection point (108) are completely consistent; the shape and size of the first member (65) and the second member (66) and the inserting barrel bolt connection point (10) are completely consistent 8) The first member (65) and the second member (66) can be installed interchangeably.

8. The fabricated negative pressure isolation chamber according to claim 7, which is characterized in that: the soiling cabinet (20), the laundry cabinet (21), the patient storage cabinet (103), the temporary soiling cabinet (104), the soiling transfer window (13) and the soiling transfer window (14) are all in the form of embedded furniture, and the embedded furniture is embedded in the interlayer by using the thickness of the interlayer of the bulkhead (106) The medical hand washing device (22), the patient hand washing device (23), the bedside groove (67) and the storage groove (68) are all in the form of niche furniture, and the niche furniture is in the form of using the thickness of the interlayer of the bulkhead (106) to form an inner concave space and making its bottom surface form a table.

9. The fabricated negative pressure isolation chamber according to claim 8, which is characterized in that a first return air pipe (71), a fan (73) and a second return air pipe (72) are arranged between the exhaust air pipe (34) and the supply air pipe (36), wherein the fan (73) is located between the first return air pipe (71) and the second return air pipe (72), and the air inlet of the fan (73) is connected with the first return air pipe (71) The air outlet is connected with the second return air pipe (72) to form an indoor gas circulation loop, the fan (73) is controlled by the air conditioning intelligent control system; all ends of the air supply pipe (36) are provided with a gas heating device (74), the gas heating device (74) is an electric heating element, the electric heating element adopts a resistance wire or an electric heating tube, and the gas heating device (74) is an electric heating element) It is controlled by the air conditioning intelligent control system connected with the temperature sensor.

10. The fabricated negative pressure isolation chamber according to claim 9, which is characterized in that: the bilge (107) interlayer is provided with a sewage pre disinfection device (75), the sewage pre disinfection device (75) comprises an inlet pipe (76), a serpentine pipe (77), an outlet pipe (78) and a sewage treatment intelligent control system (79), and the inlet pipe (76) is provided with a disinfectant dosing device (85) A water inlet valve (80) is arranged between the water inlet pipe (76) and the serpentine pipe (77), a water outlet valve (81) is arranged between the serpentine pipe (77) and the water outlet pipe (78), the position of the water inlet valve (80) is higher than that of the water outlet valve (81), an air flow stirring device (82) is arranged at the elbow of the serpentine pipe (77), and the air flow stirring device (82) is connected with the blower (84)) The water inlet valve (80), the water outlet valve (81), the blower (84), the disinfectant dosing device (85) and the air flow mixing device (82) are all controlled by the sewage treatment intelligent control system (79) The sewage treatment intelligent control system (79) is linked with the flushing device of the toilet (24).
